(19) United States
(12) Patent Application Publication
(10) Pub. No.: US 2005/0047481 A1
(43) Pub. Date: Mar. 3, 2005

(54) Network controller having dynamic hop sequence adjustment in FHSS

(75) Inventors: Ruthie D. Lyle, Durham, NC (US); Jamel Pleasant Lynch JR., Carrboro, NC (US); Mcgill Quinn, Durham, NC (US); William Vigilante JR., Scranton, PA (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/650,519

(22) Filed: Aug. 28, 2003

(51) Int. Cl. H04B 1/713

(52) U.S. Cl. 375/132

(57) ABSTRACT

A frequency hopping spread spectrum network controller is disclosed which mitigates interference from adjacent frequency hopping spread spectrum networks. The controller is adapted to detect information related to the hop sequence of an adjacent interfering network and alter its own hop sequence based on the information related to the interfering hop sequence.

### BACKGROUND OF THE INVENTION

This invention pertains to controllers for frequency hopping spread spectrum (FHSS) networks and, more particularly, to a frequency hopping spread spectrum network controller which alters its hop sequence based on a neighboring frequency hopping spread spectrum network's hop sequence.

Bluetooth® ¹ technology defines a specific wireless frequency hopping spread spectrum communication link operating in the unlicensed ISM band at 2.4 GHz using a frequency hopping tranceiver. It allows real-time voice and data communications between Bluetooth® devices. The communication range of Bluetooth® devices is between 10 and 100 meters, but more commonly is limited to between 10 and 20 meters due to channel noise and power limitations of typical devices. At the present time, the communication bandwidth of Bluetooth® devices is limited to 1 Mbps.
¹ The Bluetooth word mark is owned by the Bluetooth SIG, Inc.

A “physical channel” or “channel” is defined in the Bluetooth® specification as a synchronized sequence of randomized hops between various of 79 or 23 RF channels. Each RF channel occupies 1 Mhz of bandwidth in the 2400-2483.5 MHz RF range. Whether the channel comprises 79 or 23 RF channels is predetermined and depends on the country in which the devices operate.

Bluetooth® devices within communicating range can set up ad-hoc networks by sharing a common physical channel and thereby forming what is known as a “piconet.” A piconet consists of one and only one master device which controls the piconet and a maximum of 7 slave devices. Typically, the master communicates to the slave in a 625 μs time-slot and the slave replies to the master in the very next time-slot. This technique is known as Time Division Duplexing (TDD). The two consecutive slots are referred to as a frame. Each frame can be thought of as a call and response between the master device and the corresponding slave device.

Piconets are formed in an ad hoc fashion by having all devices continuously scan for inquiries in the area where they are operating. Any device, at any time, can initiate an inquiry. The device that initiates the inquiry takes on the role of the master device in the piconet. Devices in the range of the master's inquiry reply to the inquiry. These replying devices assume the role of a slave device in the piconet. All devices can have the capacity to fulfill both the master role and the slave role. The distinction between master and slave allows easier synchronization over the frequency hopping spread spectrum communications link. All slaves synchronize to the master and the master sets the frequency hopping sequence.

A Bluetooth® device can participate in more than one piconet by applying time multiplexing. To participate on a selected one of several channels/piconets, the device uses the associated master device address and the masterclock value of the selected channel, and locally applies a proper time shift to obtain the correct phasing therefore.

A Bluetooth® unit can act as a slave in several piconets, but only as a master in a single piconet. Thus, what might be considered as two separate piconets having a common master would, by definition, be synchronized and would use the same hopping sequence and would therefore actually constitute one and the same piconet.

A limited number of overlapping piconets can autonomously operate because of Bluetooth's frequency-hopping mechanism in which each piconet uses a different pseudo-random frequency hopping sequence wherein each pseudo-random sequence is seeded by the master's device address and is therefore a unique sequence. However, collisions are inevitable. Moreover, as the number of overlapping piconets are increased, collisions become increasingly likely and are problematic.

The IDC forecasts that by 2004 roughly 103.1 million Bluetooth® devices will be enabled in the U.S. and 451.9 million devices world wide. Consequently, the probability of interference resulting from neighboring piconets become increasingly probable. In the event of co-channel and adjacent interference, collisions occur which cause data packet retransmissions. The collisions and retransmissions result in a undesirable reduction in the data rate. Depending on the number, range, and comparable signal strength of neighboring piconets mitigating this interference is important. In many applications, such as voice over IP, even the smallest degradation in the signal is highly undesirable because it degrades the quality of the signal to an unusable degree. Moreover, in a typical office environment, the simultaneous operation of multiple Bluetooth® piconets will crowd the spectrum and increase the probability of signal degradation due to increased collision frequency.

### SUMMARY OF THE INVENTION

A novel technology is introduced herein which addresses the aforementioned problems and which is applicable to frequency hopping spread spectrum network controllers in general and more specifically to both current and future Bluetooth® controllers. The invention includes dynamically adjusting the hop sequence of a piconet based upon the hop sequence of neighboring piconets to mitigate interference. This invention addresses both single and multislot interference.

A controller is disclosed herein which includes an interference detector and a hop sequencer formed on a common substrate. The interference detector detects interference from an interfering network and determines the characteristics of the interfering network. The characteristics can include the hop sequence of the interfering network or data relating thereto. The hop sequencer controls the hop sequence of the controller and alters the hop sequence of a second frequency hopping spread spectrum network based upon the characteristics of the interfering network.

In one embodiment, logic is included which provides the capability to join the interfering network to obtain the characteristics which relate to the interfering network. Logic is also included to rejoin the original network such that the characteristics of the interfering network are made available on the original network. Optionally, the interfering network characteristics can be transferred over the original network.

### BRIEF DESCRIPTION OF THE DRAWINGS

Some of the purposes of the invention having been stated, others will appear as the description proceeds, when taken in connection with the accompanying drawings, in which:

FIG. 1 illustrates an integrated circuit controller formed in a silicon substrate in accordance with an embodiment of the present invention;

FIG. 2 is a block diagram of the components included with one embodiment of the controller of FIG. 1;

FIG. 3 is a block diagram depicting the components included with another embodiment of the controller of FIG. 1; and

FIG. 4 depicts a mapping in accordance with an embodiment of the present invention between hop frequencies used in an interfering network and the hop frequencies used in another network.

### DETAILED DESCRIPTION OF THE ILLUSTRATIVE EMBODIMENTS

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Although the illustrative embodiments will be described as modifications to existing Bluetooth controllers, the invention here described is applicable to frequency hopping spread spectrum controllers in general. For the most part, details concerning frequency hopping spread spectrum networks in general, and Bluetooth networks in particular, have been omitted in as much as such details are not necessary to obtain a complete understanding of the present invention and are within the skills of persons of ordinary skill in the relevant art. Details concerning Bluetooth networks can be obtained from Volume I of the Bluetooth Core Specification which is available through the Bluetooth SIG, Inc. The core specification is entitled Specification of the Bluetooth System. At the time of this writing, version 1.0 B dated Dec. 1, 1999 had been listed as the current version.

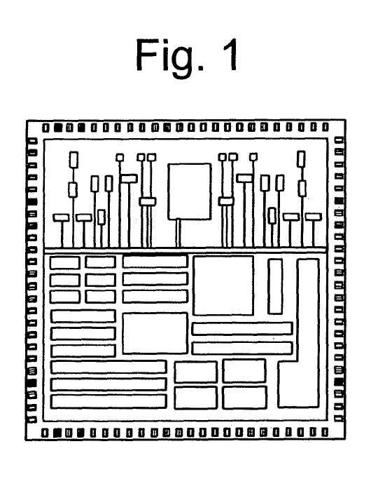

Referring now more particularly to the accompanying drawings, FIG. 1 illustrates an integrated circuit controller formed in a silicon substrate and configured in accordance with an embodiment of the present invention.

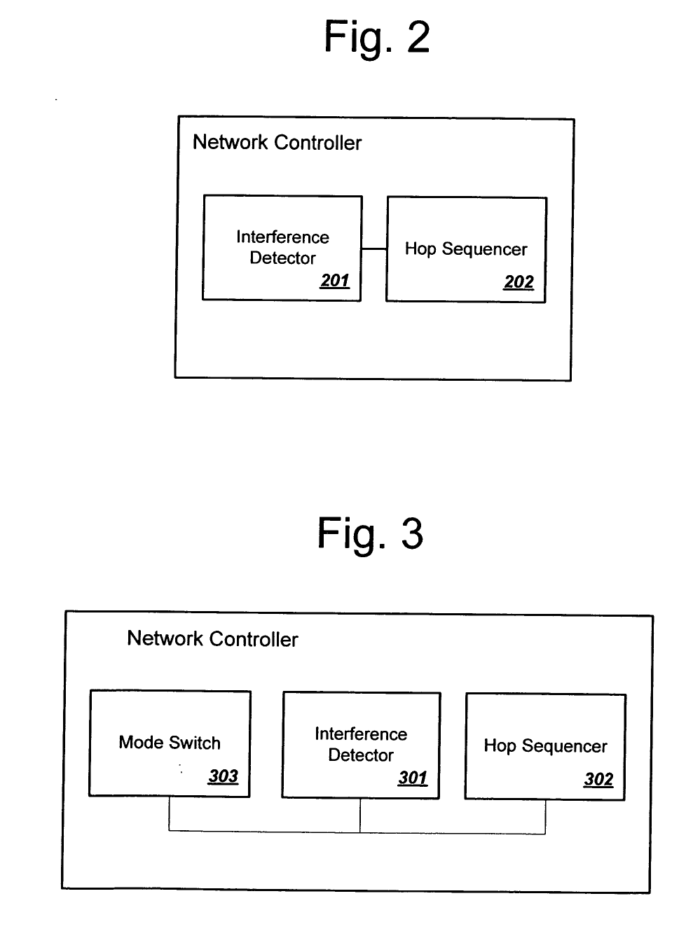

FIG. 2 is a block diagram of the components included with one embodiment of the controller of FIG. 1. In this embodiment, an interference detector 201 and a hop sequencer 202 are formed on a common silicon substrate. The interference detector detects interference from a neighboring piconet. The interference detection itself can be in the form of detecting a degradation in data throughput on the piconet in which the controller is currently operating. Alternatively, the interference detection can simply be the detection of a second piconet operating within the same area. Interference detector 201 also determines interfering hop sequence data or characteristics relating to the interfering network. This can be done by obtaining the data through a nearby access point or hub to which the interfering network shares common functionality. However, in the preferred embodiment, the interference detector 201 contains logic which joins the interfering network and thereby obtains and stores the hopping sequence of the interfering network and or data or parameters associated with the hopping sequence of the interfering network. As part of data retained by interference detector 201 which pertains to the interfering network, the controller optionally retains a correlated timestamp which correlates the sequence of the interfering network to any other sequence. Alternatively, any other means of correlating the interfering sequence to the sequences of other networks is usable. For example, since the sequences are deterministic, logic on board the controller can be implemented such that the correlation can be made. This is accomplished by recording portions of the interfering sequence using, for example, spare microprocessor bandwidth on board the controller wherein a simulation can be enacted to reverse engineer and identify the sequence and its state relative to another hop sequence. Logic on the controller would follow both Piconets simultaneously when making the correlation. In this way a timestamp is not necessarily needed.

The interfering hop sequence data obtained by interference detector 201 can additionally be obtained externally from a device on the Piconet having a controller as herein described, that controller having at least an interference detector 201.

The hop sequencer 202 is coupled to the interference detector and contains logic which alters the hop sequence of its own network based upon the interfering hop sequence data determined by the interference detector. As with Bluetooth networks, it is desirable in the preferred embodiment to hop on all 79 channels in the spectrum since maintaining the usage of all 79 channels minimizes the overall chances of experiencing collisions. The altered hop sequence is selected by any heuristic or deterministic method, specific examples of which are given in the embodiments which follow.

FIG. 3 is a block diagram depicting the components included with another embodiment of the controller of FIG. 1. In this embodiment, it is also desirable to hop on all available channels since the usage of all available channels provides a more robust connection. Where the embodiment is implemented as a Bluetooth network, the entire set of RF channels available is either 79 or 23. The number of RF channels can change depending on the country in which operation occurs. In some countries the number of RF channels available is 79, in other countries only 23 RF channels are available. In the case that only 23 channels are available in any given country, all 23 channels are used for hopping.

Mode switch 303 contains logic which selects the hopping mode from at least two modes of operation. The first mode is a mode which dictates the hopping sequence for a given network; in the case of a Bluetooth network, this mode is referred to as the master mode. The second mode is a mode which follows the hopping sequence set elsewhere on the network; this second mode is referred to as the slave mode in Bluetooth networks. However, no distinction as to master or slave is given according to the present embodiment since it is foreseeable that masters can become slaves and slaves become masters within a given piconet. Typically, only one device on a network sets the hopping frequency and all other devices follow. However, it is possible to allow different devices on the network to take over the task of setting the hopping sequence for the network. This capability allows a master to become a slave on the current network in order to become a master on another network or to otherwise join another network without collapsing the current network.

Interference detector 301 includes logic which detects interference from a nearby network operating within range of interference detector 301. Interference detector 301 also includes logic to detect or otherwise determine the interfering hop sequence of the interfering frequency hopping spread spectrum network. If the frequency hopping spread spectrum network is of the Bluetooth variety, the hopping sequences are deterministic and therefore the only data needed is that data which defines the hopping sequence of the interfering network. Since it is possible for some devices on a network to experience interference while others experience none or little, the device detecting the interference at interference detector 301 is likely to be positioned so as to favorably detect the interfering hop sequence data from the nearby interfering network. Although any one device on a network is able to detect the interference, that one device need not be charged with the responsibility to obtain the interfering hop sequence data; another device can be charged with the responsibility. While not required, in the preferred embodiment, the device which detects interference is also the device which determines the interfering hop sequence data of the interfering network. If it is a Bluetooth style network, the preferred method of obtaining the interfering hop sequence data is by joining the interfering network and recording the interfering hop sequence parameters and thereafter rejoining the original network and reporting the interfering hop sequence parameters to the original network. This reportage can be to the master device or in general to the device which is operating in the mode which sets the hopping sequence for the original network as selected by the mode switch 303. However, if it is the master device itself which detects the interference and desires to join the interfering network in order to attain the interfering hop sequence data, then no reportage is necessary over the network since the master device itself retains the interfering hop sequence data in local memory. As mapped to the current Bluetooth technology, the master device is the device which operates in the mode which sets the hopping sequence of the original network as selected by mode switch 303. When the master rejoins the original network, it does so with knowledge of the interfering hop sequence as stored in its own local memory. Whether it is the slave or the master which ventures out and joins the interfering network and comes back and rejoins the original network is arbitrary and is set by mode switch 33. However, in the preferred embodiment it is the slave mode device or the device operating in the mode which follows the hopping sequence which temporarily leaves the original network and joins the interfering network to obtain the interfering hop sequence data. In the preferred embodiment, slave mode venturing is preferred because a master would have to collapse the network in order to join the interfering network. However, other embodiments may be devised in which it is possible for a master to pass the responsibility of maintaining the current network to another device on the network such that a network need not collapse in order for a master to temporarily join another network.

In an alternative embodiment, no original network need exist. A device which is about to instigate a network can first check for the existence of other networks which could interfere with a network which is about to be initiated. The device could join the interfering network, obtain the interfering hop sequence data, and then proceed to instigate an ad-hoc network having knowledge of the interfering network's hop sequence in such a way that the initiated hop sequence tends to not coincide statistically with the interfering network's hop sequence using any of the methods described hereinbelow. In this alternative embodiment, since it is the master device which detects the interference and joins the interfering network, interference detector 301 is set to perform this function when mode switch 303 indicates that the device is to operate in the mode which sets the hopping sequence (master).

Referring again to the embodiment of FIG. 3, hop sequencer 302 includes logic which either dictates the hopping sequence for the network in which it operates, or follows the hopping sequence set by another device on the network as a function of mode switch 303. In either mode, the hop sequencer comprises a pseudo-random number generator or the like to set or follow the pseudo-random hop sequence. In addition, hop sequencer 302 includes logic which obtains the interfering hop sequence data of a nearby interfering network by either accepting the interfering hop sequence data over the network—when the data is reported by another device over the network—, or by reading the interfering hop sequence data from local storage—when the data was obtained by the same device and is therefore available locally. The local storage can reside in either the hop sequencer 302, or the interference detector 301. Alternatively, the local storage can reside in a register anywhere within the controller or within any memory accessible from the controller of the present embodiment.

Hop sequencer 302 additionally includes logic which alters its dictated hop sequence while operating in the mode which dictates the hopping sequence as indicated by the mode switch 303. This however, does not preclude a device which had been operating in the mode which follows the hopping sequence to switch its mode to a mode which dictates the hop sequence as would be the case when a slave detects the interference and rejoins the network. In other embodiments, it is possible that the slave when rejoining the original network negotiates with the existing master and takes over the responsibility of master in the original network. This would be the case when limited processing is available on typical devices and the time required to devise a new hopping sequence is extensive and perhaps beyond the capability of the processor while a device is in full master mode operation. The alteration of the hop sequence is based upon the obtained interfering hop sequence data and is calculated so as to minimize collisions between the two networks. The altered-hop-sequence calculation can be by heuristic methods when enough processing power and memory is available within the controller. Alternatively, the altered hop sequence can be calculated by deterministic methods; several examples of which are given hereinbelow. In any case, the altered hop sequence comprises the same number of RF channels as are available. That is, the altered hop sequence contains all 79 or all 23 available RF channels, over the long run, depending on the country in which the device operates.

The heuristic and deterministic methods can involve seeding the pseudo-random number generator with candidate-alternative values and comparing the resulting sequence to the interfering sequence. In all cases, the heuristic and deterministic methods can be either simulated or actually attempted in real time. The heuristic and deterministic methods can also involve using alternate pseudo-random number generator circuits rather than alternate seeding; in this case the circuit to be used for any particular sequence is communicated over the network for all devices on the network. However, alternate seeding is preferred over alternate circuitry/logic because embodiments can be implemented using mostly or entirely existing hardware. On the other hand, when pseudo-random number generator circuits are implemented in software onboard the controller, embodiments which utilize alternate circuitry are feasible.

One example of an altered hop sequence using a heuristic method, as calculated by the hop sequencer 302, is to iteratively offset the existing hop sequence by a constant number of slots and determine if the offset altered sequence would produce (or produces) fewer collisions than the existing sequence. If several offset altered sequences are found to produce fewer collisions, the offset altered sequence which is found to produce the fewest collisions is the sequence selected for the alteration. Weights can be assigned such that the decision is made based on whether fewer collisions occur in the short-term or whether fewer occur over the long-term.

Note that the term -offset-, as used herein, differs from its meaning in the Bluetooth® specification. As used in the Bluetooth® specification, -clock offset- and -offset- refer to that number μs which must be added or taken away from a local slave clock to bring it into alignment with a master clock on the same piconet, usually 625 μs or less. Conversely, as used herein, the term -offset- refers to an offset in the pseudo-random sequence of an unassociated piconet which hops on an altogether different sequence, in which case alignment is neither possible nor desired. In embodiments where the sequence is selected to be the sequence of the neighboring piconet, the offset is large (preferably>6 ms) and is in a direction which causes an intentional misalignment of the hop sequences. In otherwords, where an embodiment utilizes a sequence offset, there is no attempt to align phases with the neighboring piconets; phase alignment, or “clock offset” referred to in the Bluetooth® specification, still applies to masters and slaves within the piconets of this invention which, in addition, have a sequence offset as disclosed herein. Therefore, as used herein, the term-offset-refers to the relatively larger-scale extra-piconet offset to sequences and not to the microscale intra-piconet phase alignments which still occur.

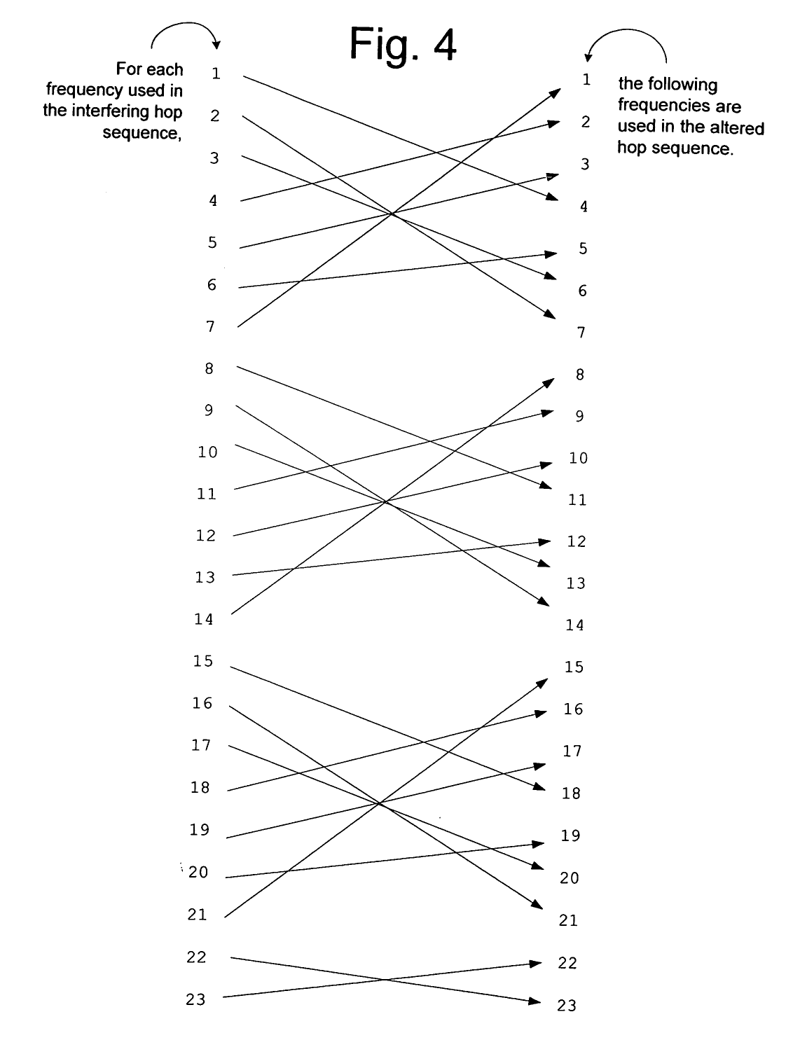

An example of an altered hop sequence using a deterministic method, as calculated by the hop sequencer 302, is to adopt a variation of the interfering hop sequence which tends to produce fewer collisions than a random sequence. One such method is to introduce a translation to the interfering hop sequence. The resulting altered hop sequence of this example is produced by the method described above requiring an alternate circuit. Thus, in this example, it is preferable that the pseudo-random number generator circuitry be implemented in software. One such translation is shown in FIG. 4 wherein an example is shown for the 23-hop-sequence systems. For each frequency used in the interfering fop sequence shown on the left hand side of FIG. 4, the frequencies shown on the right hand side of FIG. 4 are used in the altered hop sequence. Such a translator can be built in RAM as a look-up table with address values representing the left column of FIG. 4, and data values representing the translated values on the right. In this manner, a look-up value of 2 would return a translated value of 7. Another such translation is to introduce an offset to the interfering hop sequence. Still another translation is to introduce an even number to odd number translation based on the interfering hop sequence.

In the drawings and specifications there has been set forth a preferred embodiment of the invention and, although specific terms are used, the description thus given uses terminology in a generic and descriptive sense only and not for purposes of limitation.

1. Apparatus comprising:
(a) a substrate;
(b) an interference detector formed on the substrate which detects interference from an interfering network and determines interfering hop sequence data relating to the interfering network, wherein the interfering network is a frequency hopping spread spectrum (FHSS) network in which a predetermined number of FHSS channels are used for frequency hopping; and
(c) a hop sequencer which is formed on the substrate and coupled to said interference detector and which alters the hop sequence of a second FHSS network based upon the interfering hop sequence data;
wherein the altered hop sequence comprises the same number of channels as the predetermined number of FHSS channels.

2. Apparatus of claim 1 wherein the altered hop sequence is a sequence which reduces the frequency of collisions between the first and second networks.

3. Apparatus of claim 2 wherein the altered hop sequence is the hop sequence of the interfering network having a predetermined translation applied thereto.

4. Apparatus of claim 1 wherein the altered hop sequence is an offset altered sequence.

5. Apparatus of claim 4 wherein the offset altered sequence is the hop sequence of the second network having an offset applied thereto.

6. Apparatus of claim 4 wherein the offset altered sequence is the hop sequence of the interfering network having an offset applied thereto.

7. Apparatus of claim 1 wherein said interference detector (b) detects interference as a degradation in network performance on the second network.

8. Apparatus comprising:
(a) a mode switch formed on a substrate which selects a hop sequence operating mode in a frequency hopping spread spectrum (FHSS) network in which a predetermined number of FHSS channels are used for frequency hopping, wherein the selected mode is one of at least a mode which dictates a hopping sequence and a mode which follows a hopping sequence;
(b) an interference detector which is formed on the substrate and coupled to said mode switch and which detects interference from an interfering network and joins the interfering network and determines interfering hop sequence data relating to the interfering network and thereafter joins a second network and based upon the mode selected by said mode switch performs a first predetermined action wherein the first predetermined action is an action selected from the group consisting of
(i) reporting the interfering hop sequence data over the second network, and
(ii) saving the interfering hop sequence data in local storage; and
(c) a hop sequencer which is formed on the substrate and coupled to said mode switch and which obtains the interfering hop sequence data by performing a second predetermined action wherein the second predetermined action is an action selected from the group consisting of
(iii) accepting the interfering hop sequence data over the second network, and
(iv) reading the interfering hop sequence data from local storage, and which alters its dictated hop sequence while operating in the mode which dictates the hopping sequence based upon the obtained interfering hop sequence data;
wherein the altered hop sequence comprises the same number of channels as the predetermined number of FHSS channels.

9. Apparatus of claim 8 wherein the altered hop sequence is a sequence which reduces the frequency of collisions between the first and second networks.

10. Apparatus of claim 9 wherein the altered hop sequence is the hop sequence of the interfering network having a predetermined translation applied thereto.

11. Apparatus of claim 8 wherein the altered hop sequence is an offset altered sequence.

12. Apparatus of claim 11 wherein the offset altered sequence is the hop sequence of the second network having an offset applied thereto.

13. Apparatus of claim 11 wherein the offset altered sequence is the hop sequence of the interfering network having an offset applied thereto.

14. Apparatus of claim 8 wherein said interference detector (b) detects interference as a degradation in network performance on the second network.

15. Apparatus comprising:
(a) a mode switch formed on a substrate which selects a hop sequence operating mode in a frequency hopping spread spectrum (FHSS) network in which a predetermined number of FHSS channels are used for frequency hopping, wherein the selected mode is one of at least a mode which dictates a hopping sequence and a mode which follows a hopping sequence;
(b) an interference detector which is formed on the substrate and coupled to said mode switch and which detects interference from an interfering network and joins the interfering network and determines interfering hop sequence data relating to the interfering network and thereafter joins a second network and based upon the mode selected by said mode switch performs any one of
(i) reporting the interfering hop sequence data over the second network, and
(ii) saving the interfering hop sequence data in local storage; and
(c) a hop sequencer which is formed on the substrate and coupled to said mode switch and which obtains the interfering hop sequence data by one of
(iii) accepting the interfering hop sequence data over the second network, and
(iv) reading the interfering hop sequence data from local storage, and which alters its dictated hop sequence while operating in the mode which dictates the hopping sequence based upon the obtained interfering hop sequence data;
wherein the altered hop sequence comprises the same number of channels as the predetermined number of FHSS channels.
